(19) United States
(12) Patent Application Publication
(10) Pub. No.: US 2008/0203596 A1
(43) Pub. Date: Aug. 28, 2008

(54) Molding Machine, Injection Apparatus, and Temperature Control Method for the Apparatus

(75) Inventor: Norihito Okada, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd., Shinagawa-ku, Tokyo (JP)

(21) Appl. No.: 11/794,745

(22) PCT Filed: Dec. 28, 2005
(86) PCT No.: PCT/JP2005/024064

§ 371 Date: Jul. 5, 2007

(30) Foreign Application Priority Data
Jan. 6, 2005 (JP) 2005-001391
Feb. 23, 2005 (JP) 2005-046969

(51) Int. Cl. B29C 45/78

(52) U.S. Cl. 264/40.6; 425/549; 425/144

(57) ABSTRACT

An injection apparatus has a cylinder member having a feed opening (215) formed at a predetermined position; an injection member disposed within the cylinder member in a manner capable of advancing and retreating; a molding-material feed apparatus which attached to the feed opening (215) and feeds a molding material into the cylinder member through the feed opening (215); and thermoelectric cooling elements (261) to (264) disposed at predetermined positions around the feed opening (215). Since the thermoelectric cooling elements (261) to (264) are disposed at the predetermined positions around the feed opening (215), temperature around the feed opening (215) can be brought to an appropriate value, and the response of temperature control can be enhanced. Thermoelectric cooling elements (g) are disposed between a housing (152) of a drive section and a heat transfer member, whereby heat generated within the housing (152) is transmitted to the heat transfer member via the housing (152) and emitted to the exterior of the drive section. Accordingly, rated torque generated by driving the drive section can be increased.

### TECHNICAL FIELD

The present invention relates to a molding machine, an injection apparatus, and a temperature control method for the apparatus.

### BACKGROUND ART

Conventionally, in a molding machine; for example, an injection molding machine, a resin heated and melted in a heating cylinder is injected under high pressure into a cavity of a mold apparatus so as to fill the cavity; and the resin within the cavity is cooled to set, thereby yielding a molded product.

The injection molding machine has a mold apparatus, a mold-clamping apparatus, and an injection apparatus. The injection apparatus includes a heating cylinder for heating and melting a resin, and an injection nozzle for injecting the molten resin. A screw is disposed within the heating cylinder rotatably and in a manner capable of advancing and retreating. The mold-clamping apparatus advances and retreats a movable mold to thereby close, clamp, and open the mold apparatus. As a result of the mold apparatus being clamped, a cavity is formed between a stationary mold and the movable mold.

By means of driving an injection motor, which serves as an injection drive section, so as to advance the screw, the resin is injected into the cavity from the injection nozzle and fills the cavity. By means of driving a metering motor, which serves as a metering drive section, so as to rotate the screw, the resin is metered, and molten resin is stored ahead of a screw head.

The screw has a feed section, a compression section, and a metering section. In a metering step, the resin dropping from a hopper is fed to the feed section through a feed opening; the fed resin is melted while being compressed in the compression section; and the molten resin is metered by a predetermined amount in the metering section. In the compression section, the outside diameter of a body of the screw; i.e., a screw body, increases towards the front. Thus, a gap between the screw body and the heating cylinder decreases towards the front, whereby the resin is compressed (refer to, for example, Patent Document 1).

A plurality of heaters are disposed on the outer circumference of the heating cylinder and on the outer circumference of the injection nozzle; a plurality of temperature sensors are disposed on the heating cylinder at predetermined positions; and the temperature sensors detect temperatures of the heating cylinder. On the basis of detected temperatures, the individual heaters are separately energized so as to separately control temperatures at the predetermined positions of the heating cylinder, thereby controlling resin temperature such that the resin has different temperatures at the predetermined positions of the heating cylinder.

Incidentally, if temperature around the feed opening becomes high, the resin fed from the hopper will be immediately melted, disabling smooth metering. In order to cope with this problem, a water-cooling cylinder is disposed adjacent to the feed opening, and water is circulated to the water-cooling cylinder so as to cool the periphery of the feed opening, thereby maintaining the periphery at an appropriate temperature for preventing melting of the resin.

The mold-clamping apparatus includes a stationary platen to which the stationary mold is attached; a toggle support disposed in opposition to the stationary platen; four tie bars extending between the stationary platen and a toggle plate; a movable platen, which is disposed in a manner capable of advancing and retreating along the tie bars and to which the movable mold is attached; a toggle mechanism, which is disposed between the toggle support and the movable platen and which expands or bendingly contracts; and a mold-clamping motor, which serves as a mold-clamping drive section for operating the toggle mechanism. When the mold-clamping motor is driven to operate the toggle mechanism for advancing the movable platen, mold closing is performed; subsequently, a mold-clamping force is generated, thereby performing mold clamping. When the toggle mechanism is operated to retreat the movable platen, mold opening is performed. Notably, the mold-clamping force is transmitted to the movable mold via the movable platen; resultantly, a reaction force of the mold-clamping force is transmitted to the toggle support via the tie bars.

As mentioned above, the metering motor and the injection motor are provided for rotating, advancing, and retreating the screw; the mold-clamping motor is disposed for operating the toggle mechanism; and the motors are separately driven. In order to increase the rated capacities of the motors, each motor has a fan for air-cooling itself (refer to, for example, Patent Document 2).

Patent Document 1: Japanese Patent Application Laid-Open (kokai) No. 11-227019
Patent Document 2: Japanese Patent Application Laid-Open (kokai) No. 7-40408

### DISCLOSURE OF THE INVENTION

### Problems to be Solved by the Invention

However, in the conventional injection apparatus, since water circulated to the water-cooling cylinder has large thermal capacity, the response of temperature control drops. This lengthens time required to bring temperature around the feed opening to an appropriate value.

Also, in the conventional injection molding machine, the operation of an air-cooling fan generates noise and scatters dust.

In order to cope with the above problem, there is provided a drive-section-temperature-regulating apparatus which is configured such that a temperature-regulating medium circulation system is formed between a motor and a temperature regulator and in which a temperature-regulating medium is circulated for cooling the motor. However, in this case, not only must the temperature regulator be disposed, but also measures to prevent leakage of the temperature-regulating medium from the circulation system must be taken, resulting in an increase in the cost of the drive-section-temperature-regulating apparatus.

An object of the present invention is to solve the above-mentioned problems in the conventional injection molding machine and to provide an injection apparatus and a temperature control method for the apparatus in which temperature around a feed opening can be brought to an appropriate value and in which the response of temperature control is enhanced.

Another object of the present invention is to provide a molding machine which allows an increase in the rated capacity of a drive section and a reduction in the cost of a drive-section-temperature-regulating apparatus.

### Means for Solving the Problems

To achieve the above objects, a molding machine of the present invention comprises a cylinder member having a feed opening formed at a predetermined position; an injection member disposed within the cylinder member in a manner capable of advancing and retreating; a metering drive section which rotates the injection member; an injection drive section which advances the injection member; a mold apparatus having a stationary mold and a movable mold; a mold-clamping apparatus which performs mold closing, mold clamping, and mold opening of the mold apparatus; a mold-clamping drive section disposed in the mold-clamping apparatus; a molding-material feed apparatus which attached to the feed opening and feeds a molding material into the cylinder member through the feed opening; and a thermoelectric cooling element disposed at a predetermined position.

An injection apparatus of the present invention comprises a cylinder member having a feed opening formed at a predetermined position; an injection member disposed within the cylinder member in a manner capable of advancing and retreating; a molding-material feed apparatus which attached to the feed opening and feeds a molding material into the cylinder member through the feed opening; and a thermoelectric cooling element disposed at a predetermined position around the feed opening.

Another molding machine of the present invention comprises a housing which accommodates a stator and a rotor; a heat transfer member which covers an outer surface of the housing and has recesses and projections; and a thermoelectric cooling element which is disposed between the housing and the heat transfer member such that a cooling surface of the thermoelectric cooling element faces the outer surface of the housing.

### EFFECT OF THE INVENTION

According to the present invention, the molding machine comprises a cylinder member having a feed opening formed at a predetermined position; an injection member disposed within the cylinder member in a manner capable of advancing and retreating; a metering drive section which rotates the injection member; an injection drive section which advances the injection member; a mold apparatus having a stationary mold and a movable mold; a mold-clamping apparatus which performs mold closing, mold clamping, and mold opening of the mold apparatus; a mold-clamping drive section disposed in the mold-clamping apparatus; a molding-material feed apparatus which attached to the feed opening and feeds a molding material into the cylinder member through the feed opening; and a thermoelectric cooling element disposed at a predetermined position.

In this case, since a thermoelectric cooling element is disposed at a predetermined position, temperature around the predetermined position can be brought to an appropriate value, and the response of temperature control can be enhanced.

The injection apparatus of the present invention comprises a cylinder member having a feed opening formed at a predetermined position; an injection member disposed within the cylinder member in a manner capable of advancing and retreating; a molding-material feed apparatus which attached to the feed opening and feed a molding material into the cylinder member through the feed opening; and a thermoelectric cooling element disposed at a predetermined position around the feed opening.

In this case, since a thermoelectric cooling element is disposed at a predetermined position around the feed opening, temperature around the feed opening can be brought to an appropriate value, and the response of temperature control can be enhanced.

Another molding machine of the present invention comprises a housing which accommodates a stator and a rotor; a heat transfer member which covers an outer surface of the housing and has recesses and projections; and a thermoelectric cooling element which is disposed between the housing and the heat transfer member such that a cooling surface of the thermoelectric cooling element faces the outer surface of the housing.

In this case, since a thermoelectric cooling element is disposed between the housing and the heat transfer member such that the cooling surface of the thermoelectric cooling element faces the outer surface of the housing, heat generated within the housing is transmitted to the heat transfer member via the housing and emitted to the exterior of the drive section.

Accordingly, rated torque generated by driving the drive section can be increased, so that the rated capacity of the drive section can be increased. Furthermore, durability of bearings can be enhanced. Also, not only is there no need to dispose a temperature regulator, but also there is no need to take measures to prevent leakage of a temperature-regulating medium from a circulation system, so that the cost of a drive-section-temperature-regulating apparatus can be lowered.

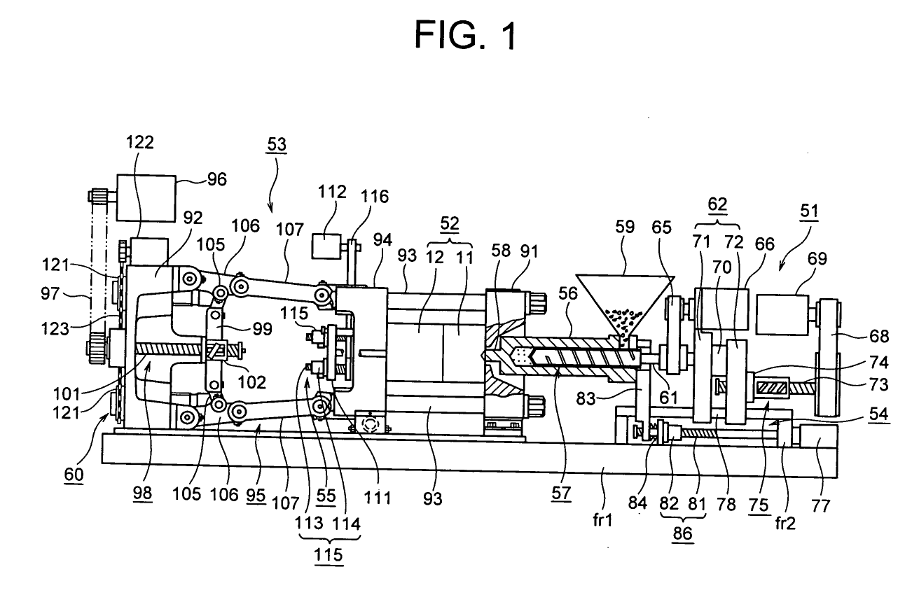

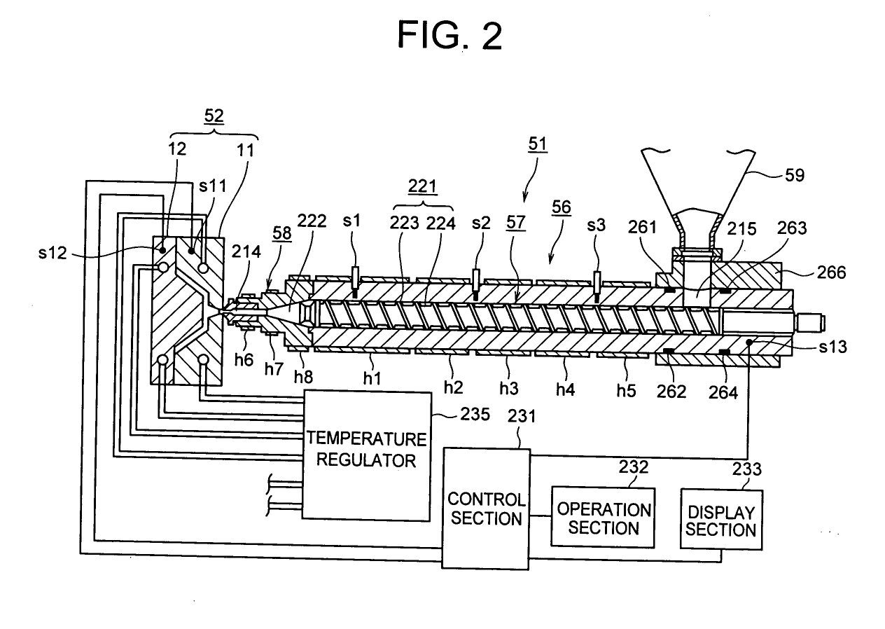

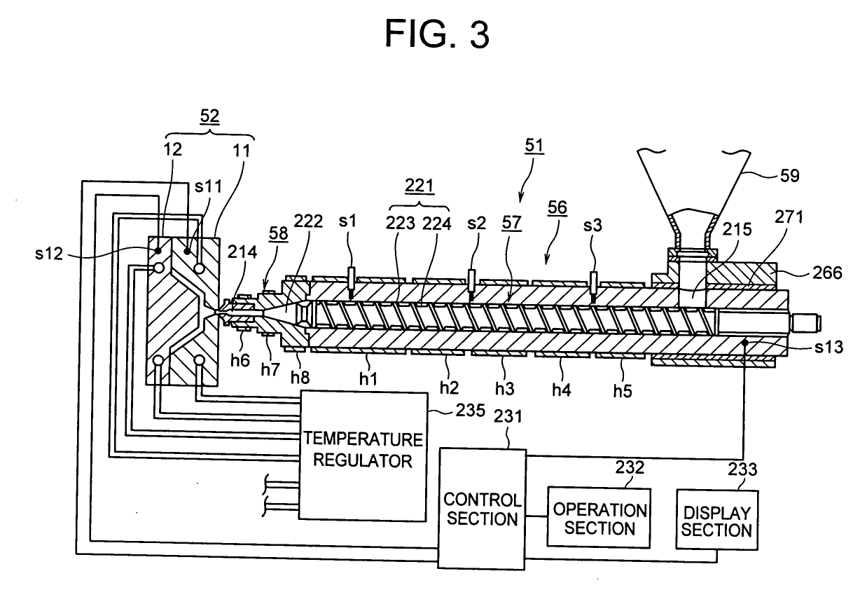

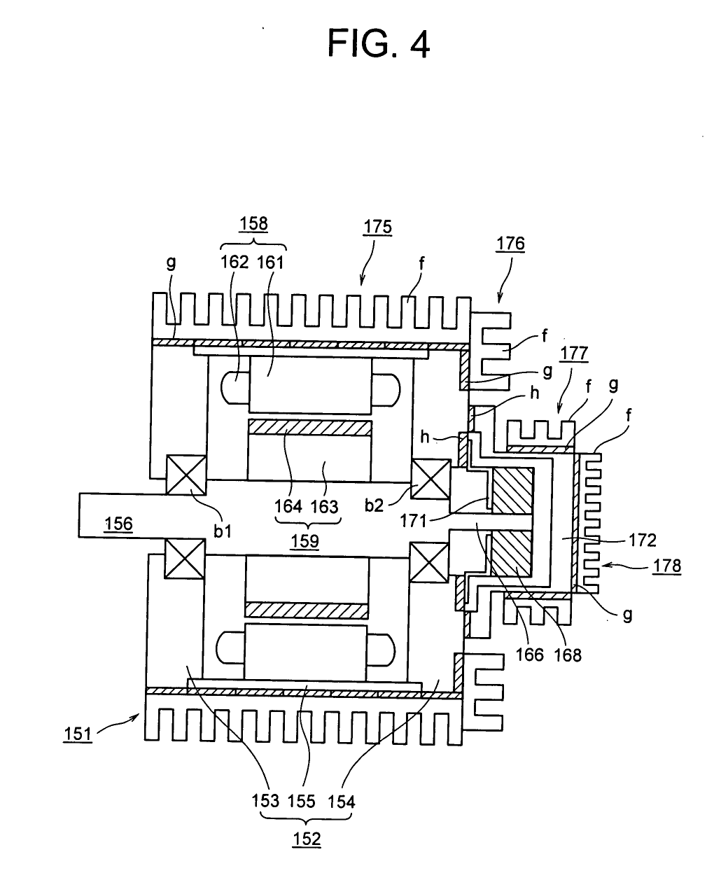

### BRIEF DESCRIPTION OF THE DRAWINGS

[FIG. 1] Conceptual view of an injection molding machine according to a first embodiment of the present invention.

[FIG. 2] View showing essential portions of the injection molding machine according to the first embodiment of the present invention.

[FIG. 3] View showing essential portions of an injection molding machine according to a second embodiment of the present invention.

[FIG. 4] Schematic view of a drive-section-temperature-regulating apparatus according to a third embodiment of the present invention.

### DESCRIPTION OF REFERENCE NUMERALS

11: stationary mold
12: movable mold
51: injection apparatus
52: mold apparatus
53: mold-clamping apparatus
56: heating cylinder
57: screw
59: hopper
66: metering motor
69: injection motor
96: mold-clamping motor
152: housing
156: output shaft
158: stator
159: rotor
168: encoder
171: bracket
172: cover
175, 176, 266: heatsink
215: feed opening
231: control section
261 to 264, 271, g, h: thermoelectric cooling element
s1 to s3: heater temperature sensor

### BEST MODE FOR CARRYING OUT THE INVENTION

Embodiments of the present invention will next be described with reference to the drawings. A molding machine to be described is an injection molding machine.

FIG. 1 is a conceptual view of an injection molding machine according to a first embodiment of the present invention.

In FIG. 1, reference numeral 51 denotes an injection apparatus; reference numeral 52 denotes a mold apparatus composed of a stationary mold 11, which serves as a first mold, and a movable mold 12, which serves as a second mold; reference numeral 53 denotes a mold-clamping apparatus disposed in opposition to the injection apparatus 51; reference numeral 54 denotes a plastifying-and-moving apparatus, which supports the injection apparatus 51 in such a manner that the injection apparatus 51 can advance and retreat; reference numeral 55 denotes an ejector apparatus; reference numeral 60 denotes a mold-thickness-adjusting apparatus, which functions as a toggle-adjusting apparatus; and reference numeral fr1 denotes a molding-machine frame, which supports the injection apparatus 51, the mold-clamping apparatus 53, the plastifying-and-moving apparatus 54, and the like.

The injection apparatus 51 includes a heating cylinder 56, which serves as a cylinder member; a screw 57, which serves as an injection member and is disposed within the heating cylinder 56 rotatably and in a manner capable of advancing and retreating; an injection nozzle 58 attached to a front end of the heating cylinder 56; a hopper 59 disposed in the vicinity of a rear end of the heating cylinder 56; a screw shaft 61 projecting from a rear end of the screw 57; a pressure plate 62, which serves as a movable support section, includes a front support member 71 and a rear support member 72 connected together via a load cell 70, is disposed in a manner capable of advancing and retreating, and rotatably supports the screw shaft 61, the load cell 70 serving as a load detection member, the front support member 71 serving as a first support member, and the rear support member 72 serving as a second support member; a metering motor 66, which serves as a metering drive section, is attached to the front support member 71, and is connected to the screw shaft 61 via a pulley-and-belt-type rotation transmission system (composed of a drive pulley, which serves as a drive element, a follower pulley, which serves as a follower element, and a timing belt, which serves as a transmission member and extends between the drive pulley and the follower pulley) 65; and an injection motor 69, which serves as an injection drive section, is attached to the molding-machine frame fr1, and is connected to a ball screw 75, which serves as a motion-direction conversion section, via a pulley-and-belt-type rotation transmission system (composed of a drive pulley, which serves as a drive element, a follower pulley, which serves as a follower element, and a timing belt, which serves as a transmission member and extends between the drive pulley and the follower pulley) 68.

The ball screw 75 functions as a motion-direction conversion section for converting a rotary motion to a rectilinear motion and includes a ball screw shaft 73, which serves as a first conversion element and is connected to the rotation transmission system 68, and a ball nut 74, which serves as a second conversion element, is attached to the rear support member 72, and is in screw-engaged with the ball screw shaft 73.

The plastifying-and-moving apparatus 54 includes a molding-machine frame fr2; a plastifying-and-moving motor 77, which serves as a plastifying-and-moving drive section and is attached to the molding-machine frame fr2; a guide 78 disposed along the longitudinal direction of the molding-machine frame fr2 and adapted to guide the front support member 71 and the rear support member 72; a ball screw shaft 81, which serves as a first conversion element, is disposed rotatably relative to the molding-machine frame fr2, and is rotated through driving of the plastifying-and-moving motor 77; a ball nut 82, which serves as a second conversion element and is in screw-engaged with the ball screw shaft 81; a bracket 83 attached to a rear end of the heating cylinder 56; and a spring 84, which serves as a force-applying member and is disposed between the ball nut 82 and the bracket 83.

Accordingly, by means of driving the plastifying-and-moving motor 77, the injection apparatus 51 can be advanced at a predetermined timing so as to cause the injection nozzle 58 to abut the stationary mold 11, thereby performing a nozzle touch. The ball screw shaft 81 and the ball nut 82 constitute a ball screw 86. The ball screw 86 functions as a motion-direction conversion section for converting a rotary motion to a rectilinear motion.

The mold-clamping apparatus 53 includes a stationary platen 91, which serves as a first stationary member and is attached to the molding-machine frame fr1; a toggle support 92, which serves as a second stationary member; tie bars 93 extending between the stationary platen 91 and the toggle support 92; a movable platen 94, which serves as a movable member and is disposed in opposition to the stationary platen 91 and in a manner capable of advancing and retreating along the tie bars 93; a toggle mechanism 95 disposed between the movable platen 94 and the toggle support 92; a mold-clamping motor 96, which serves as a mold-clamping drive section; a pulley-and-belt-type rotation transmission system (composed of a drive pulley, which serves as a drive element, a follower pulley, which serves as a follower element, and a timing belt, which serves as a transmission member and extends between the drive pulley and the follower pulley) 97 for transmitting rotation generated through driving of the mold-clamping motor 96 to the toggle mechanism 95; a ball screw 98, which serves as a motion-direction conversion section and is connected to the rotation transmission system 97; and a crosshead 99, which serves as a moving member and is connected to the ball screw 98. The stationary mold 11 and the movable mold 12 are attached to the stationary platen 91 and the movable platen 94, respectively, in such a manner that the stationary mold 11 and the movable mold 12 face each other.

The ball screw 98 functions as a motion-direction conversion section for converting a rotary motion to a rectilinear motion and includes a ball screw shaft 101, which serves as a first conversion element and is connected to the rotation transmission system 97, and a ball nut 102, which serves as a second conversion element, is attached to the crosshead 99, and is in screw-engaged with the ball screw shaft 101.

The toggle mechanism 95 includes toggle levers 105, which are pivotably supported by the crosshead 99; toggle levers 106, which are pivotably supported by the toggle support 92; and toggle arms 107, which are pivotably supported by the movable platen 94. The toggle levers 105 and the corresponding toggle levers 106 are linked together, and the toggle levers 106 and the corresponding toggle arms 107 are linked together.

By means of advancing and retreating the crosshead 99 between the toggle support 92 and the movable platen 94 through operation of the mold-clamping motor 96, the toggle mechanism 95 advances and retreats the movable platen 94 along the tie bars 93, thereby bringing the movable mold 12 in contact with and moving the movable mold 12 away from the stationary mold 11 for performing mold closing, mold clamping, and mold opening.

The ejector apparatus 55 is disposed on the rear side of the movable platen 94 and includes a crosshead 111, which serves as a movable member and is disposed in a manner capable of advancing and retreating relative to the movable platen 94; an ejection motor 112, which serves as an ejection drive section; ball screw shafts 113, which serve as first conversion elements and are disposed rotatably relative to the crosshead 111; ball nuts 114, which serve as second conversion elements, are attached to the crosshead 111, and are in screw-engaged with the corresponding ball screw shafts 113; a pulley-and-belt-type rotation transmission system (composed of a drive pulley, which serves as a drive element, a follower pulley, which serves as a follower element, and a timing belt, which serves as a transmission member and extends between the drive pulley and the follower pulley) 116 for transmitting rotation generated through driving of the ejection motor 112 to the ball screw shafts 113; and an ejector rod and ejector pins (not shown) which advance and retreat as the crosshead 111 advances and retreats.

Accordingly, by means of driving the ejection motor 112, a molded product which remains in the movable mold 12 in a mold opening step can be ejected from the movable mold 12. The ball screw shafts 113 and the ball nuts 114 constitute ball screws 115. The ball screws 115 function as a motion-direction conversion section for converting a rotary motion to a rectilinear motion.

The mold-thickness-adjusting apparatus 60 is in screw-engaged with threaded portions formed at rear ends of the tie bars 93 and includes adjustment nuts 121, which serve as toggle-adjusting members and as mold-thickness-adjusting members; a mold-thickness motor 122, which serves as a toggle-adjustment drive section and as a mold-thickness-adjustment drive section; and a timing belt 123, which serves as a transmission member and transmits rotation generated through driving of the mold-thickness motor 122 to the adjustment nuts 121. Accordingly, for example, in the case where the mold apparatus 52 is replaced, a mold thickness can be adjusted by advancing or retreating the toggle support 92 relative to the stationary platen 91 through driving of the mold-thickness motor 122.

In the injection apparatus 51 having the aforementioned configuration, when the plastifying-and-moving motor 77 is driven, the rotation of the plastifying-and-moving motor 77 is transmitted to the ball screw shaft 81, thereby advancing or retreating the ball nut 82. A thrust force of the ball nut 82 is transmitted to the bracket 83 via the spring 84, thereby advancing or retreating the injection apparatus 51.

In a metering step, the metering motor 66 is driven, and the rotation of the metering motor 66 is transmitted to the screw shaft 61 via the rotation transmission system 65, thereby rotating the screw 57. As a result, an unillustrated resin, which serves as a molding material and is fed from the hopper 59, is melted within the heating cylinder 56 through application of heat. The molten resin moves frontward and is stored ahead of the screw 57. In the course of this operation, the screw 57 is retreated to a predetermined position.

In an injection step, the injection nozzle 58 is pressed against the stationary mold 11; the injection motor 69 is driven; and the ball screw shaft 73 is rotated via the rotation transmission system 68. At this time, the load cell 70 moves in association with rotation of the ball screw shaft 73, thereby advancing the screw 57. As a result, the resin which is stored ahead of the screw 57 is injected from the injection nozzle 58 and fills a cavity formed between the stationary mold 11 and the movable mold 12. An associated reaction force is borne by the load cell 70 and detected as an injection force.

In the mold-clamping apparatus 53 and the ejector apparatus 55 having the aforementioned configurations, when the mold-clamping motor 96 is driven, the rotation of the mold-clamping motor 96 is transmitted to the ball screw shaft 101 via the rotation transmission system 97, thereby advancing or retreating the ball nut 102. This causes the crosshead 99 to advance or retreat. Advancement of the crosshead 99 expands the toggle mechanism 95, thereby advancing the movable platen 94 and thus performing mold closing. Accordingly, the movable mold 12 abuts the stationary mold 11. Subsequently, the mold-clamping motor 96 is further driven, causing the toggle mechanism 95 to generate a mold-clamping force. The mold-clamping force presses the movable mold 12 against the stationary mold 11, thereby forming a cavity between the stationary mold 11 and the movable mold 12. Meanwhile, when the crosshead 99 is retreated, the toggle mechanism 95 bendingly contracts so as to retreat the movable platen 94, thereby performing mold opening.

Subsequently, the ejection motor 112 is driven, and rotation generated through driving of the ejection motor 112 is transmitted to the ball screw shafts 113 via the rotation transmission system 116, thereby advancing and retreating the crosshead 111. This causes the ejector rods to advance and retreat. In the course of mold opening, advancing the crosshead 111 through driving of the ejection motor 112 advances the ejector pins, thereby ejecting a molded product.

In the mold-thickness-adjusting apparatus 60 having the aforementioned configuration, when the mold-thickness motor 122 is driven, the rotation of the mold-thickness motor 122 is transmitted to the adjustment nuts 121 via the timing belt 123, thereby rotating the adjustment nuts 121. As a result of being rotated, the adjustment nuts 121 advance or retreat in relation to the tie bars 93, thereby advancing or retreating the toggle support 92. As a result, a mold thickness is adjusted, and the reference position of the toggle mechanism 95 is adjusted.

Next, the injection apparatus 51 will be described.

FIG. 2 is a view showing essential portions of the injection molding machine according to the first embodiment of the present invention.

In FIG. 2, reference numeral 51 denotes an injection apparatus; reference numeral 56 denotes a heating cylinder; reference numeral 57 denotes a screw disposed within the heating cylinder 56 rotatably and in a manner capable of advancing and retreating; reference numeral 58 denotes an injection nozzle attached to a front end of the heating cylinder 56; reference numeral 214 denotes a nozzle port formed in the injection nozzle 58; reference numeral 215 denotes a feed opening formed in the heating cylinder 56 at a predetermined position in the vicinity of a rear end of the heating cylinder 56 and adapted to feed resin therethrough; and reference numeral 59 denotes a hopper, which serves as a molding-material feed apparatus, accommodates the resin, and feeds the resin into the heating cylinder 56 through the feed opening 215.

The metering motor 66, the injection motor 69, etc. are disposed behind the rear end of the screw 57. The screw 57 includes a flight portion 221 and a screw head 222 attached to a front end of the flight portion 221. The flight portion 221 has a flight 223 formed spirally on the outer circumferential surface of a screw body, and a spiral groove 224 is formed along the flight 223.

The screw 57 has, from the rear to the front, a feed section into which resin dropping from the hopper 59 is fed; a compression section which compresses and melts the fed resin; and a metering section which meters the molten resin by a constant amount. The outside diameter of the screw body as measured at the bottom of the groove 224 is relatively small in the feed section; gradually increases from the rear to the front in the compression section; and is relatively large in the metering section. Accordingly, a gap between the inner circumferential surface of the heating cylinder 56 and the outer circumferential surface of the screw body is relatively large in the feed section; gradually decreases from the rear to the front in the compression section; and is relatively small in the metering section.

The mold apparatus 52 is disposed ahead of the injection apparatus 51; the mold apparatus 52 includes the stationary mold 11 and the movable mold 12 disposed in a manner capable of advancing and retreating relative to the stationary mold 11; operation of the mold-clamping apparatus 53 effects mold closing, mold clamping, and mold opening of the mold apparatus 52; and, at the time of mold clamping, a cavity is formed between the stationary mold 11 and the movable mold 12. Accordingly, the mold-clamping apparatus 53 includes the stationary platen 91 to which the stationary mold 11 is attached; the movable platen 94 to which the movable mold 12 is attached; and the mold-clamping motor 96 adapted to advance and retreat the movable platen 94 and to generate a mold-clamping force.

In a metering step, when the screw 57 is rotated in the regular direction through driving of the metering motor 66, resin accommodated in the hopper 59 is fed into the feed section through the feed opening 215 and is advanced along the groove 224. In the course of this operation, the screw 57 is retreated, and the resin is stored ahead of the screw head 222. Notably, the resin in the groove 224 assumes the form of pellets in the feed section and a semi-molten condition in the compression section and is completely melted into a liquid condition in the metering section.

In an injection step, when the screw 57 is advanced through driving of the injection motor 69, the resin which is stored ahead of the screw head 222 is injected from the injection nozzle 58 and fills the cavity. In order to prevent backflow of the resin stored ahead of the screw head 222, an unillustrated backflow-preventing apparatus including a backflow-preventing ring and a seal ring is disposed around the screw head 222.

Meanwhile, a plurality of heaters h1 to h5 are disposed axially adjacent to one another on the outer circumference of the heating cylinder 56; heaters h6 to h8 are disposed on the outer circumference of the injection nozzle 58; and, by individually energizing the heaters h1 to h8, the resin in the heating cylinder 56 can be melted through application of heat.

Heater-temperature sensors s1 to s3, which serve as temperature detection sections, are disposed in the heating cylinder 56 at a plurality of predetermined axial positions; in the present embodiment, at a central position of the heater h1, at a position between the heaters h2 and h3, and at a position between the heaters h4 and h5.

The heater-temperature sensors s1 to s3 detect temperatures of the heating cylinder 56 at predetermined positions; i.e., in the vicinity of the front end of the heating cylinder 56, at the center of the heating cylinder 56, and in the vicinity of the rear end of the heating cylinder 56, and send the detected temperatures to a control section 231. An unillustrated molding-temperature control processing means (processing section) of the control section 231 carries out molding-temperature control processing. Specifically, on the basis of the detected temperatures, the molding-temperature control processing means energizes the heaters h1 to h8 such that the resin is maintained at set temperatures. An operation section 232 and a display section 233 are connected to the control section 231. The set temperatures can be entered from the operation section 232. An unillustrated display processing means (processing section) of the control section 231 carries out display processing, thereby displaying the set temperatures, the detected temperatures, etc. on the display section 233.

In order to control the temperature of the mold apparatus 52, mold-temperature sensors s11 and s12, which serve as temperature detection sections, are disposed. The mold-temperature sensors s11 and s12 detect the temperature of the stationary mold 11 and the temperature of the movable mold 12, respectively, and send the detected temperatures to the control section 231. An unillustrated mold-temperature control processing means (processing section) of the control section 231 carries out mold-temperature control processing. Specifically, the mold-temperature control processing means controls a temperature regulator 235 so as to regulate the flow rate of water, which serves as a temperature-regulating medium and is supplied from the temperature regulator 235, and supplies thus-regulated water to the mold apparatus 52.

Meanwhile, if the temperature of the heating cylinder 56 as measured at the feed opening 215 is higher than a melting point of resin, the resin which is fed to the feed section will be melted immediately, thereby disabling smooth metering. In order to cope with this problem, thermoelectric cooling elements 261 to 264 are disposed at predetermined locations around the feed opening 215; in the present embodiment, at frontward and rearward positions in the vicinity of the feed opening 215.

Each of the thermoelectric cooling elements 261 to 264 is a Peltier module, which is a unit consisting of pairs of p-type and n-type semiconductors electrically connected in series, each pair having a cooling capability. When a dc current is applied between the opposite end semiconductors, one side of each semiconductor serves as a cooling surface, and the other side serves as a heating surface. By means of changing the direction of current, the thermoelectric cooling elements 261 to 264 can function as cooling elements or as heating elements.

In the present embodiment, the thermoelectric cooling elements 261 to 264 function as cooling elements. Accordingly, the cooling surfaces of the thermoelectric cooling elements 261 to 264 face a radially inward side of the heating cylinder 56, and the heating surfaces face a radially outward side of the heating cylinder 56. A heatsink 266 is disposed radially outward of the thermoelectric cooling elements 261 to 264 in such a manner as to surround the heating cylinder 56. The heatsink 266 is formed from a material of high thermal conductivity and emits, to the atmosphere, heat which is emitted from the thermoelectric cooling elements 261 to 264. The heatsink 266 may have heat radiation fins as needed.

A feed-opening temperature sensor s13, which serves as a temperature detection section, is disposed at a predetermined position in the periphery of the feed opening 215; in the present embodiment, in the vicinity and rearward of the thermoelectric cooling element 264. The feed-opening temperature sensor s13 detects temperature around the feed opening 215 and sends the detected temperature to the control section 231. An unillustrated feed-opening temperature control processing means (processing section) of the control section 231 carries out feed-opening temperature control processing, thereby controlling the thermoelectric cooling elements 261 to 264 so as to regulate temperature around the feed opening 215.

Accordingly, when the heating cylinder 56 is heated through energization of the heaters h1 to h8, transmission of heat to the feed opening 215 can be restrained, and the periphery of the feed opening 215 can be maintained at an appropriate temperature as well. This prevents immediate melting of resin fed to the feed section, so that metering can be performed smoothly.

For example, in the case where the periphery of the feed opening 215 is cooled by means of a water-cooling cylinder, since circulated water has large thermal capacity, response of temperature control drops. By contrast, in the case where the thermoelectric cooling elements 261 to 264 are used, cooling can be immediately started merely by energizing the thermoelectric cooling elements 261 to 264, so that response of temperature control can be enhanced. Accordingly, time required to bring temperature around the feed opening 215 to an appropriate value can shortened.

In the present embodiment, the thermoelectric cooling elements 261 to 264 function as cooling elements, but can function as thermally stabilizing elements. In this case, the direction of current is reversed to the case of functioning as cooling elements, and the cooling surfaces of the thermoelectric cooling elements 261 to 264 are directed toward the radially outward side of the heating cylinder 56, whereas the heating surfaces of the thermoelectric cooling elements 261 to 264 are directed toward the radially inward side of the heating cylinder 56. As a result, the heatsink 266 absorbs heat from the atmosphere and transmits the heat to the thermoelectric cooling elements 261 to 264, thereby heating the heating cylinder 56.

In this case, since the temperature of the heating cylinder 56 can be stabilized, temperature around the feed opening 215 can be stabilized.

Meanwhile, variation of a retreat limit position of the screw 57 at the time of completion of a metering step causes variation of an effective stroke of the screw 57, resulting in variation in a metered quantity. If such variation is the case, the amount of heat required to melt resin for a single execution of metering varies. Also, variation in the period of a molding cycle causes variation in the amount of heat per unit time required to melt resin.

For example, when the metered quantity becomes large or when the molding cycle becomes short, a required amount of heat increases, and the temperature of resin drops. By contrast, when the metered quantity becomes small or when the molding cycle becomes long, a required amount of heat decreases, and the temperature of resin increases.

According to the present embodiment, by means of changing the direction of current, the thermoelectric cooling elements 261 to 264 can be made to function as cooling elements or as thermally stabilizing elements in accordance with variation of a metered quantity, a molding cycle, or the like. Therefore, the temperature of resin can be stabilized.

Accordingly, load imposed on the screw 57 can be made constant, thereby improving not only injection characteristics but also quality of molded products.

Also, before or when the operation of the injection molding machine is started, the periphery of the feed opening 215 can be heated to a predetermined temperature by making the thermoelectric cooling elements 261 to 264 function as heating elements. This can shorten the time required to raise the temperature of the heating cylinder 56 to a molding start temperature.

The present embodiment uses a material of high thermal conductivity to form the heat sink 266. However, in place of a material of high thermal conductivity, a water-cooling cylinder can be used. In this case, the water-cooling cylinder enables not only auxiliary cooling of the periphery of the feed opening 215 with water but also transmission of heat emitted from the thermoelectric cooling elements 261 to 264 to water. Since water has large thermal capacity, heat emitted from the thermoelectric cooling elements 261 to 264 can be sufficiently transmitted to water.

Next, a second embodiment of the present invention will be described. Like structural elements of the first and second embodiments are denoted by like reference numerals, and repeated description thereof is omitted. For the effect that the second embodiment yields through employment of structural elements similar to those of the first embodiment, the effect that the first embodiment yields is applied accordingly.

FIG. 3 is a view showing essential portions of an injection molding machine according to a second embodiment of the present invention.

In this case, a thermoelectric cooling element 271 is disposed at a predetermined position in the periphery of the feed opening 215 of the heating cylinder 56, which serves as a cylinder member; in the present embodiment, in a region adjacent to the feed opening 215 and extending from a front side of the feed opening 215 to a rear side of the feed opening 215. The thermoelectric cooling element 271 is disposed in such a cylindrical manner as to substantially cover the outer circumferential surface of a rear portion of the heating cylinder 56.

Incidentally, the metering motor 66 (FIG. 1), the injection motor 69, the plastifying-and-moving motor 77, the mold-clamping motor 96, the ejection motor 112, the mold-thickness motor 122, and the like generate heat when they are driven. Thus, an unillustrated drive-section-temperature-regulating apparatus is disposed on each of the motors for the purpose of cooling the motors.

Next, the drive-section-temperature-regulating apparatus will be described. Since the metering motor 66, the injection motor 69, the plastifying-and-moving motor 77, the mold-clamping motor 96, the ejection motor 112, the mold-thickness motor 122, and the like have the same basic structure, a typical motor common to the motors will be described.

FIG. 4 is a schematic view of a drive-section-temperature-regulating apparatus according to a third embodiment of the present invention.

In FIG. 4, reference numeral 151 denotes a motor; reference numeral 152 denotes a housing of metal; and the housing 152 includes a first flange portion 153, a second flange portion 154, and a stator frame 155. Bearings b1 and b2 are disposed in the first and second flange portions 153 and 154, respectively. An output shaft 156 is rotatably supported by the bearings b1 and b2. A stator 158 is attached to the inner circumferential surface of the stator frame 155. A rotor 159 is attached to the outer circumferential surface of the output shaft 156.

The stator 158 includes a stator core 161 and a coil 162. The rotor 159 includes a rotor core 163 and permanent magnets 164. The permanent magnets 164 are disposed circumferentially on the rotor core 163 at a predetermined circumferential pitch. Accordingly, when a predetermined current is supplied to the coil 162, the rotor 159 is rotated at a predetermined rotational speed; resultantly, the output shaft 156 is rotated.

Incidentally, in order to control the rotational speed of the motor 151, the rotational speed of the motor 151 is detected. Specifically, a rotation output portion 166 projects from an end portion of the output shaft 156. An encoder 168, which serves as a rotational-speed detector, is disposed on an end of the rotation output portion 166.

The encoder 168 includes an unillustrated to-be-detected section, which is a rotational member attached to the rotation output portion 166, and an unillustrated detecting section which generates a sensor output in accordance with rotation of the to-be-detected section. The detecting section is attached to the second flange portion 154 via a bracket 171, which serves as a support member and is formed of a metal having elasticity. The encoder 168 is enclosed in a sealed condition by a cover 172 of metal. According to the present embodiment, the encoder 168 is used as a rotational-speed detector. However, in place of the encoder 168, a resolver can be used.

Since the motor 151 is driven through supply of current to the coil 162, the coil 162 generates heat. Also, the bearings b1 and b2 generate heat through rotation thereof. If these heats are accumulated within the housing 152, the rated torque which is generated through driving of the motor 151 cannot be increased. Particularly, in an injection molding machine, in the case where a dwell pressure must be applied for a long period of time after a cavity is filled with resin, the magnitude of a rated torque is more important than that of a peak torque. In this case, if a rated torque of the injection motor 69 (FIG. 1) is insufficient for molding conditions concerned, the temperature of the injection motor 69 increases, resulting in a failure to continue production of molded products.

In order to cope with the above problem, heatsinks 175 and 176, which have recesses and projections and serve as heat transfer members and as heat radiation members, are disposed in such a manner as to cover the outer surface of the stator frame 155 and a peripheral portion of the second flange portion 154. Each of the heatsinks 175 and 176 has a plurality of fins f.

When heat generated through rotation of the bearing b2 is accumulated within the cover 172, the accuracy of detection of rotational speed drops. Furthermore, in the case where the motor 151 has a brake, the brake is disposed adjacent to the encoder 168, and heat is generated through engagement of the brake. Similarly, when heat generated through engagement of the brake is accumulated within the cover 172, the accuracy of detection of rotational speed drops.

In order to cope with the above problem, heatsinks 177 and 178 are disposed in such a manner as to cover the outer circumferential surface and the end surface, respectively, of the cover 172. Each of the heatsinks 177 and 178 has a plurality of fins f.

An unillustrated cooling fan is disposed at a predetermined position on the outside of the motor 151. On the basis of temperature detected by an unillustrated temperature detector, the control section 231 (FIG. 2) operates the cooling fan, and the thus-generated air flow is caused to impinge on the heatsinks 175 to 178. Accordingly, heat within the housing 152 is transmitted to the heatsinks 175 and 176 via the housing 152 and is then emitted to the exterior of the motor 151. Also, heat within the cover 172 is transmitted to the heatsinks 177 and 178 via the cover 172 and is then emitted to the exterior of the motor 151.

Incidentally, when air which impinges on the heatsinks 175 to 178 is low in temperature, heat can be emitted in a sufficient amount through the heatsinks 175 to 178. However, when the temperature of air is high, heat cannot be emitted in a sufficient amount. In order to emit heat in a sufficient amount irrespective of temperature of air, thermoelectric cooling elements g are disposed between the stator frame 155 and the heat sink 175, between the second flange portion 154 and the heat sink 176, and between the cover 172 and the heatsinks 177 and 178.

Incidentally, each of the thermoelectric cooling elements g is a Peltier module, which is a unit consisting of pairs of p-type and n-type semiconductors electrically connected in series, each pair having a cooling capability. When a dc current is applied between the opposite end semiconductors, one side of each semiconductor serves as a cooling surface, and the other side serves as a heating surface. By means of changing the direction of current, the thermoelectric cooling elements g can function as heating elements or as cooling elements; i.e., one side of each thermoelectric cooling element g serves as a cooling surface, whereas the other side serves as a heating surface.

In the present embodiment, the thermoelectric cooling elements g function as cooling elements. Accordingly, the thermoelectric cooling elements g are disposed such that the cooling surfaces of the thermoelectric cooling elements g face the outer surfaces of the stator frame 155, the first and second flange portions 153 and 154, and the cover 172, whereby the stator frame 155, the first and second flange portions 153 and 154, and the cover 172 are cooled. Accordingly, heat within the housing 152 is transmitted to the heatsinks 175 and 176 via the stator frame 155 and the first and second flange portions 153 and 154 and is then emitted to the exterior of the motor 151. Heat within the cover 172 is transmitted to the heatsinks 177 and 178 via the cover 172 and is then emitted to the exterior of the motor 151. In this case, the thermoelectric cooling elements g have a function to transmit heat of the stator frame 155 and the first and second flange portions 153 and 154 to the heatsinks 175 and 176 and a function to transmit heat of the cover 172 to the heatsinks 177 and 178, and serve as heat transmission elements.

Since the bracket 171 and the cover 172 are attached to the second flange portion 154, if heat of the second flange portion 154 is not sufficiently emitted via the heatsink 176 and is transmitted to the bracket 171 and the cover 172, the bracket 171 and the cover 172 cannot be cooled sufficiently. As a result, since the temperature of the encoder 168 increases, the accuracy of detection drops.

In order to cope with the above problem, thermoelectric cooling elements h are disposed between the second flange portion 154 and the bracket 171 and between the second flange portion 154 and the cover 172. The thermoelectric cooling elements h function as cooling elements. Thus, the thermoelectric cooling elements h are disposed such that the cooling surfaces of the thermoelectric cooling elements h face the outer surface of the second flange portion 154, whereby the second flange portion 154 is cooled. Accordingly, transmission of heat of the second flange portion 154 to the bracket 171 and the cover 172 can be cut off, and the bracket 171 and the cover 172 can be sufficiently cooled. Thus, an increase in temperature of the encoder 168 can be prevented. As a result, the accuracy of detection of the encoder 168 can be enhanced. In this case, the thermoelectric cooling elements h have a function to cut off transmission of heat of the second flange portion 154 to the bracket 171 and the cover 172, and thus serve as heat cutoff elements.

As described above, since heat within the housing 152 can be sufficiently emitted to the exterior of the motor 151, a rated torque which is generated through driving of the motor 151 can be increased, and the rated capacity of the motor 151 can be increased. Furthermore, durability of the bearings b1 and b2 can be enhanced.

Also, not only is there no need to dispose a temperature regulator, but also there is no need to take measures to prevent leakage of a temperature-regulating medium from a circulation system, so that the cost of a drive-section-temperature-regulating apparatus can be lowered.

Since heat within the cover 172 can be sufficiently emitted to the exterior of the motor 151, and transmission of heat to the encoder 168 can be cut off, the accuracy of detection of the encoder 168 can be enhanced. Also, durability of the encoder 168 can be enhanced.

Furthermore, the control section 231 can operate a cooling fan and control the thermoelectric cooling elements h, etc. on the basis of the result of detection by the temperature detector.

The present invention is not limited to the above-described embodiments. Numerous modifications and variations of the present invention are possible in light of the spirit of the present invention, and they are not excluded from the scope of the present invention.

### INDUSTRIAL APPLICABILITY

The present invention can be applied to an injection molding machine.

1. A molding machine characterized by comprising:
(a) a cylinder member having a feed opening formed at a predetermined position;
(b) an injection member disposed within the cylinder member in a manner capable of advancing and retreating;
(c) a metering drive section which rotates the injection member;
(d) an injection drive section which advances the injection member;
(e) a mold apparatus having a stationary mold and a movable mold;
(f) a mold-clamping apparatus which performs mold closing, mold clamping, and mold opening of the mold apparatus;
(g) a mold-clamping drive section disposed in the mold-clamping apparatus;
(h) a molding-material feed apparatus which attached to the feed opening and feeds a molding material into the cylinder member through the feed opening; and
(i) a thermoelectric cooling element disposed at a predetermined position.

2. An injection apparatus characterized by comprising:
(a) a cylinder member having a feed opening formed at a predetermined position;
(b) an injection member disposed within the cylinder member in a manner capable of advancing and retreating;
(c) a molding-material feed apparatus which attached to the feed opening and feeds a molding material into the cylinder member through the feed opening; and
(d) a thermoelectric cooling element disposed at a predetermined position around the feed opening.

3. An injection apparatus according to claim 2, wherein
(a) the thermoelectric cooling element is disposed such that one side of the thermoelectric cooling element faces radially inward and such that the other side of the thermoelectric cooling element faces radially outward, and
(b) a heatsink is disposed radially outward of the thermoelectric cooling element.

4. An injection apparatus according to claim 2, wherein the thermoelectric cooling element functions as a cooling element.

5. An injection apparatus according to claim 2, wherein the thermoelectric cooling element functions as a thermally stabilizing element.

6. An injection apparatus according to claim 2, further comprising:
(a) a temperature detection section which detects temperature around the feed opening, and
(b) feed-opening temperature control processing section which controls the thermoelectric cooling element on the basis of the temperature.

7. A temperature control method for an injection apparatus characterized by comprising:
(a) feeding a molding material into a cylinder member through a feed opening which is formed in the cylinder member at a predetermined position, and
(b) regulating temperature around the feed opening by means of a thermoelectric cooling element which is disposed at a predetermined position around the feed opening.

8. A molding machine characterized by comprising:
(a) a housing which accommodates a stator and a rotor;
(b) a heat transfer member which covers an outer surface of the housing and has recesses and projections; and
(c) a thermoelectric cooling element which is disposed between the housing and the heat transfer member such that a cooling surface of the thermoelectric cooling element faces the outer surface of the housing.

9. A molding machine according to claim 8, further comprising:
(a) a rotational-speed detector disposed at one end of an output shaft and detects a rotational speed of the output shaft;
(b) a cover which is attached to the housing and encloses the rotational-speed detector;
(c) a heat transfer member which covers an outer surface of the cover and has recesses and projections; and
(d) a thermoelectric cooling element which is disposed between the cover and the heat transfer member such that a cooling surface of the thermoelectric cooling element faces the outer surface of the cover.

10. A molding machine according to claim 8, wherein a to-be-detected section of the rotational-speed detector is attached to the housing via a support member.

11. A molding machine according to claim 8, further comprising:
(a) a temperature detector which detects temperature of the stator, and
(b) a control section which controls the thermoelectric cooling element on the basis of temperature detected by the temperature detector.
